(19) United States
(12) Patent Application Publication
(10) Pub. No.: US 2003/0140089 A1
(43) Pub. Date: Jul. 24, 2003

(54) Inter-applet communication using an applet agent

(76) Inventors: Kenneth J. Hines, New Orleans, LA (US); Xuefeng Li, Metairie, LA (US)

Correspondence Address: Shawn D. Sentilles, Esq., WYATT, TARRANT & COMBS, LLP, 1715 Aaron Brenner Drive, Memphis, TN, 38120-4367, US

(21) Appl. No.: 10/266,221

(22) Filed: Oct. 8, 2002

Related U.S. Application Data
(60) Provisional application No. 60/346,994, filed on Nov. 1, 2001.

(51) Int. Cl. G06F 15/16

(52) U.S. Cl. 709/202

(57) ABSTRACT

An Applet Agent on a browser of a client processor communicates with a server processor exclusively through a server agent on the server processor. Via this secure network connection, the server agent retrieves Client Applets and client applet data from a server database and sends them to the Applet Agent. The Applet Agent sends the Client Applets and data to the browser of the client processor. The Applet Agent stores the Client Applets, data, and amended data in the client processor, whereby the Client Applets and their data can be retrieved without accessing the server processor. Upon conclusion of a session, the Applet Agents sends the Client Applet data to the server agent, which stores the data on the server database. A plurality of Client Applets are preferably arranged in a logical unit of work, whereby a finite set of the Client Applets accomplish multiple functions.

### CROSS REFERENCE TO RELATED APPLICATIONS

Applicants claim priority to the following related provisional applications: U.S. Provisional Patent Application Serial No. 60/346,994, filed Nov. 1, 2001.

### STATEMENT REGARDING FEDERALLY SPONSORED RESEARCH OR DEVELOPMENT

Not Applicable

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates to protocols for inter-applet communication. More particularly, the present invention relates to an inter-application communication system that utilizes a Java virtual machine and displays multiple applets on a single browser window while optimizing the number of server connections. The inter-applet communication system of the present invention is particularly suited to Internet-based administrative systems.

### BACKGROUND OF THE INVENTION

The Internet is a world-wide network of computers that allows users to communicate and exchange information. In order to access information on the Internet, an individual user executes a client program. In most cases, the client program is a web browser (e.g. Netscape or Microsoft Explorer). The web browser connects the user to the Internet. The browser issues specific commands to the Internet. Through these commands, the processor or computer of the user is connected to a particular web server. A web server is a computer system that provides information to the client through the Internet link. After a connection to the Internet has been established via a web server, the user can selectively access thousands of web sites from around the world. A client selects a web site from the Internet by providing the web site's address, known as a “Universal Resource Locator” (“URL”), to the web browser. A web site consists of a series of web pages or screen displays. Web pages are typically created using Hyper Text Markup Language (“HTML”). Each web page consists of text, images, data, and other information about a particular organization, company, or topic.

An application is a stand alone program, usually in executable code, that resides on a processor. When an application containing a computer virus is downloaded to a processor from the Internet, the processor may become infected. In order to avoid infection by Internet borne viruses, many Internet programs are exchanged in the form of applets. An applet is a small niche application or utility that performs just one useful task and is designed for use within larger programs. Applets are typically designed to be distributed across a network, such as the Internet, in order to add extra functionality to another program, such as a Web browser.

Most applets are written in the Java programming language. Java is highly machine independent. Programs written in Java can run on any computer that has an installed Java interpreter. Java's architecture allows machine-independent executable instructions to be distributed over a network onto a Java enabled web browser. Because of these properties, Java can run on many browser clients, including PCs, Macs, Sun workstations, PDAs, and televisions. Using small Java applets, World Wide Web pages can include functions such as animation, menus, text, data entry templates, and calculators.

An applet is not executed directly by the processor, but rather by a virtual machine. A virtual machine is software that imitates a physical device. A Java virtual machine (JVM) is built into many popular Web browsers, including Netscape Navigator and Internet Explorer. The JVM does not produce machine instructions specific to a particular processor. Instead, the JVM produces single compiled versions of the program, called bytecodes. For this reason, JVMs are also known as Java interpreters. When bytecodes are downloaded onto the web browser in the form of an applet, the JVM interprets and runs the code. Java executable instructions have only limited access to computer system resources. This feature of Java provides protection from viruses or erroneous codes from corrupting local systems.

Multiple programs having multiple applets can be run simultaneously on an operating system. Each of these programs has at least one thread within it. A thread is a parallel path of execution that runs independently. Problems can arise when multiple threads attempt to connect to a server simultaneously. When a user attempts to display or update multiple applets on a single web page, each applet must establish its own connection to the server. If two or more applets request data from the server at the same time, the applets compete with one another for a server connection. If a first applet is accessing a first data file and waiting for a second data file at the same time that another applet is accessing the second data file and waiting for the first data file, deadlock will result. Each applet may be waiting to initiate a server connection, resulting in inefficiencies.

In early uses of applet technology, applets did not know that other applets existed. In the past few years, software developers have developed systems for allowing applets to communicate with one another, or engage in “inter-applet communication.” In an article entitled A Design Pattern for Inter-Applet Communications, www.webtechniques.com/archives/1998/10/cozad (Web Techniques, October 1999), which is incorporated herein by reference, author Joseph Cozad provides a thorough discussion of the three main types of inter-applet communication that are presently in existence: (1) using AppletContext; (2) using JavaScript and Java; and (3) using the browser's Java Virtual Machine (“JVM”). The present invention relates to modifications of technique number 3, i.e. use of the browser's JVM. Cozad provides the following explanation of technique number 3:

Approach 3: Using the Browser's JVM

This approach takes advantage of the fact that only one Java virtual machine (JVM) can be running in a browser during any one session. It allows applets to communicate in any context as long as they're displayed in the same browser process. That is, it's possible to link applets in the same HTML document, or distribute them across multiple HTML documents in multiple browser windows. In addition, because this is an all-Java solution, there are no compatibility issues with browsers as with the previous approach.

The key player in this approach is a class with all static methods and no public constructor, which is called MessageRelayer (see Listing Four). The MessageRelayer is not instantiated; instead each applet that needs to communicate accesses one or more of the MessageRelayer's static class methods. The static keyword in Java means that only one instance of a method or variable is loaded into the JVM. All objects residing in the JVM then access the same class methods and variables. Because each accessing applet will be running in its own thread, each of the MessageRelayer's methods that access or change the data is synchronized.

The MessageRelayer class methods are similar to many of the methods and functions that have been examined so far. In fact, the MessageRelayer also contains a storage object, a hashtable, which stores references to the available communicating applets, as was used in the previous approach. In addition to this, three new methods have been added.

The getAppletNames( ) method returns to a calling applet a list of all the known applet names (see Listing Four, lines 36 to 50). Once an applet has the names, it can either call MessageRelayer's getApplet( ) method (lines 52 to 59) to get a reference to the applet in order to communicate directly with it; or it can use the MessageRelayer's postCommand( ) method, supplying the name and the object for the MessageRelayer to forward onto the named applet. Notice that an applet verification method (lines 67 to 76) is also added, and it's called each time the MessageRelayer retrieves an applet reference from the hashtable.

The only modification that has to be made to the basic test applet (in Listing One), is a call in the start( ) method to MessageRelayer.addAppplet(this) and a call in the stop( ) method to MessageRelayer.removeApplet(this). Because the basic test applet implements the AppletCommunicator interface, it must implement the addApplet( ) and removeApplet( ) methods. However, since each applet won't be maintaining a reference to all the other applets, these methods aren't used and can be implemented as empty methods. This isn't true for the postCommand( ) method defined by the AppletCommunicator interface. Regardless of whether the applet posts commands directly or indirectly through the MessageRelayer, this method is used.

Id., www.webtechniques.com/archives/1998/10/cozad, pp. 7-8.

Listing 1 to Mr. Cozad's article provides:

| | |
|---|---|
| 1 | import java.applet.*; |
| 2 | import java.awt.*; |
| 3 | import java.awt.event.*; |
| 4 | |
| 5 | public class TestApplet extends Applet implements ActionListener{ |
| 7 | |

| | |
|---|---|
| 8 | TextArea MessageArea; |
| 9 | Label AppletTitle; |

| | |
|---|---|
| 10 | Button SendButton; |
| 11 | TextField InputArea; |
| 12 | Vector RemoteApps = null; |
| 13 | |

| | |
|---|---|
| 14 | public void init( ){ |

| | |
|---|---|
| 15 | String name = getParameter(“name”); |
| 16 | setName(name); |
| 17 | Insets my_insets = getInsets( ); |
| 18 | |
| 19 | setBackground(Color.gray); |
| 20 | setLayout(null); |
| 21 | |
| 22 | MessageArea = new TextArea( ); |
| 23 | MessageArea.setBackground(Color.white); |
| 24 | MessageArea.setEditable(false); |
| 25 | MessageArea.setBounds(my_insets.left + 16,my_insets.top + |

| | |
|---|---|
| 26 | 32,264,71); |

| | |
|---|---|
| 27 | add(MessageArea); |
| 28 | |
| 29 | AppletTitle = new Label(name + “Messages Received:”); |
| 30 | AppletTitle.setBounds(my_insets.left + 16, my_insets.top + |

| | |
|---|---|
| 31 | 11,141,21); |

| | |
|---|---|
| 32 | add(AppletTitle); |
| 33 | |
| 34 | SendButton = new Button(“Send”); |
| 35 | SendButton.setBounds(my_insets.left + 219, my_insets.top + |

| | |
|---|---|
| 36 | 110,60,23); |

| | |
|---|---|
| 37 | SendButton.addActionListener(this); |
| 38 | add(SendButton); |
| 39 | |
| 40 | InputArea = new TextField( ); |
| 41 | InputArea.setBounds(my_insets.left + 17, my_insets.top + |

| | |
|---|---|
| 42 | 106,196,28); |

| | |
|---|---|
| 43 | InputArea.setBackground(Color.white); |
| 44 | add(InputArea); |
| 45 | } |

| | |
|---|---|
| 46 | } |
| 47 | |
| 48 | public interface AppletCommunicator{ |

| | |
|---|---|
| 49 | // defines method to send a command to another |
| 50 | // AppletCommunicator. |
| 51 | public void postCommand(Object command); |
| 52 | |
| 53 | // defines method which adds AppletCommunicators with |

| | |
|---|---|
| 54 | // which the Applet can communicate. |

| | |
|---|---|
| 55 | public void addApplet(AppletCommunicator remote_applet); |
| 56 | |
| 57 | // defines method which removes AppletCommunicators as |
| 58 | // they are removed from the browser. |
| 59 | public void removeApplet(AppletCommunicator remote_applet); |

| | |
|---|---|
| 60 | } |

Listing 4 to Mr. Cozad's article provides:

| | |
|---|---|
| 1 | import java.util.*; |
| 2 | import java.applet.Applet; |
| 3 | |
| 4 | /* |

| | |
|---|---|
| 5 | MessageRelayer maintains all the applet references. |
| 6 | You can either use the getApplet( ) method to post |
| 7 | directly to the and applet or use the postCommand( ) |
| 8 | method to post through the MessageRelayer. |

| | |
|---|---|
| 9 | */ |
| 10 | |
| 11 | public class MessageRelayer{ |
| 12 | |

| | |
|---|---|
| 13 | private static Hashtable Apps = null; // Stores Applet references. |
| 14 | |

| | |
|---|---|
| 15 | private MessageRelayer( ){} // Ensures class can't be instantiated. |
| 16 | |

| | |
|---|---|
| 17 | public static synchronized void addApplet(Applet remote_applet){ |

| | |
|---|---|
| 18 | if(Apps == null){ // Has a hashtable been created. |

| | |
|---|---|
| 19 | Apps = new Hashtable( ); |

| | |
|---|---|
| 20 | } |
| 21 | |
| 22 | Apps.put(((AppletCommunicator) |

| | |
|---|---|
| 23 | remote_applet).getName( ), remote applet); |

| | |
|---|---|
| 24 | } |
| 25 | |
| 26 | public static synchronized void removeApplet(Applet remote_applet){ |

| | |
|---|---|
| 27 | if(Apps != null){ // Hashtable must have been created first. |

| | |
|---|---|
| 28 | Apps.remove(((AppletCommunicator) remote_applet).getName( )); |

| | |
|---|---|
| 29 | } |
| 30 | |
| 31 | if(Apps.size( ) == 0){ |

| | |
|---|---|
| 32 | Apps = null; // Dereference if not in use. |

| | |
|---|---|
| 33 | } |

| | |
|---|---|
| 34 | } |
| 35 | |
| 36 | public static synchronized String[] getAppletNames( ){ |

| | |
|---|---|
| 37 | Enumeration keys = Apps.keys( ); |
| 38 | Vector names = new Vector( ); |
| 39 | |
| 40 | for(int i=0; keys.hasMoreElements( ); i++){ |

| | |
|---|---|
| 41 | names.addElement(keys.nextElement( ); |

| | |
|---|---|
| 42 | } |
| 43 | |
| 44 | String[] applet_names = new String[names.size( )]; |
| 45 | for(int i=0; i < names.size( ); i++){ |

| | |
|---|---|
| 46 | applet_names[i] = (String) names.elementAt(i); |
| 47 | } |
| 48 | |
| 49 | return(applet_names); |

| | |
|---|---|
| 50 | } |
| 51 | |

| | |
|---|---|
| 52 | public static synchronized Applet getApplet(String applet_name){ |

| | |
|---|---|
| 53 | Applet remote_applet = (Applet) Apps.get(applet_name); |
| 54 | if(verifyAppletRef(remote_applet)){ |

| | |
|---|---|
| 55 | return(remote_applet); |

| | |
|---|---|
| 56 | } else{ |

| | |
|---|---|
| 57 | return(null); |

| | |
|---|---|
| 58 | } |

| | |
|---|---|
| 59 | } |
| 60 | |
| 61 | public static void postCommand(String applet_name, Object command){ |

| | |
|---|---|
| 62 | AppletCommunicator remote_applet = |

| | |
|---|---|
| 63 | (AppletCommunicator)getApplet(applet_name); |

| | |
|---|---|
| 64 | remote_applet.postCommand(command); |

| | |
|---|---|
| 65 | } |
| 66 | |
| 67 | private static boolean verifyAppletRef(Applet remote_applet){ |

| | |
|---|---|
| 68 | boolean valid = false; |
| 69 | |
| 70 | if(remote_applet.isActive( )){ |

| | |
|---|---|
| 71 | return(true); |

| | |
|---|---|
| 72 | } else{ |

| | |
|---|---|
| 73 | removeApplet(remote_applet); |
| 74 | return(false); |
| 75 | } |

| | |
|---|---|
| 76 | } |

| | |
|---|---|
| 77 | } |

U.S. Pat. No. 6,175,877 (Zerber), which is incorporated herein by reference, discloses a system for providing communication between applets that relies on the services of a browser located on the client computer. A browser, such as an HTML web browser, is executed within a computer and a server program including a protocol, such as the HTTP protocol, is executed in the browser. A first page is executed within the browser and a first applet, such as a Java applet, is executed within the first page. A second page is executed within the browser and a second applet is executed within the second page. The second applet transmits data to the server program using the protocol. The first applet executing in the first page processes the data transmitted from the second applet to the server program. The first applet may be used to establish a connection with a remote server over a network using a second protocol, such as POP3, IMAP4, LDAP, SMTP, and transmit the data received from the second applet to the remote server via the network using the second protocol. Zerber does not use a JVM. The applets in Zerber can reside in different browser windows, but they must use a local HTTP server.

U.S. Pat. No. 5,922,044 (Banthia), which is incorporated herein by reference, discloses a system and method for simultaneously displaying a set of display applets while optimizing the number of server connections. A connection to the server is established by a controlling applet. The controlling applet receives data from the server, parses the data, transmits the data to a set of display applets, and displays the set of display applets on a single browser window. If an applet is torn off of a single browser window and moved to another window, the controlling applet continually maintains a link to the server to continually update the data values on the torn off applet as well as on the set of display applets on the single browser window. Inter-applet communication is achieved by using approach number 1 of Cozad's article. The controlling agent of Banthia pulls data from server, then goes to sleep if there is no data. It wakes up periodically to check for more data. If all applets are closed, the connection is dropped, even if the browser window is up and running. The applet agent does not stay open throughout the time that the browser window is up and running. Although Banthia discloses a plurality of applets on a screen, the set of displayed applets is predetermined, and does not change.

Inter-applet communication has been used in various applications. For example, U.S. Pat. No. 5,992,752 (Wilz et al) discloses an internet-based system for enabling information related transactions over the Internet using Java-enabled Internet terminals provided with bar code symbol readers for reading Java applet encoded bar code symbols. U.S. Pat. No. 5,951,636 (Zerber) discloses a system for accessing a post office system from a client computer using applets. U.S. Pat. No. 6,152,369 (Wilz et al) discloses a system for accessing and displaying HTML encoded documents relating to an object being worked upon in a work environment by a human operator.

As far as the inventor is aware, up to now Inter-applet communication has not been applied to administrative programs. Administrative computer programs are well known. For an example of desk top programs related to the administration of church organizations, see www.powerchurch.com. Such programs are very useful on stand alone processors or local area networks. However, administration of such programs on stand alone processors or local area networks presents logistical and resource problems, including updating a database, maintaining a database, backing up data, and installing updates to the administrative software. These shortcomings could be overcome by operating an administration program over the Internet from a host server. However, the use of administrative programs via the Internet has been limited by requirements for frequent exchanges of variable or selected information between a host server and a client processor, which requires multiple connections and consumes large amounts of computer and network resources. Additionally, conventional web-pages are not equipped for exchanging large amounts of information. With html screens, only two buttons are allowed per page, namely a “submit” button and a “reset” button, which severely limits the richness of the environment and the options that may be provided in an Internet based administrative program.

There is thus a need for a Java solution to inter-applet communication having the following objects and advantages over the prior art.

### OBJECTS AND SUMMARY OF THE INVENTION

It is an object of the invention to provide a system for inter-applet communication that uses a plurality of applets that run at the same time.

It is another object of the invention to provide a system for inter-applet communication that uses one controlling applet, designated the “Applet Agent,” to communicate directly with the host server and a plurality of secondary applets that communicate with the host server via the Applet Agent.

It is another object of the invention to provide an Internet-based system of inter-applet communication that allows for rich screen environments having many pop-up screens and selectable options.

It is another object of the invention to provide a system for inter-applet communication in which client applets can be called up as needed, rather than in a set sequential order.

It is another object of the invention to provide a system for inter-applet communication that organizes Client Applets into logical units of work.

It is another object of the invention to provide a one-hundred percent Java based protocol for inter-applet communication.

It is another object of the invention to provide a system for inter-applet communication in which client applets can communicate across an extra/inter/intra network in a secure fashion.

It is yet another object of the invention to provide a system for inter-applet communication in which client applets can achieve persistence of objects at the client machine.

It is still another object of the invention to provide a system for inter-applet communication in which plurality of client applets can communicate with distributed servers in a fashion which optimizes the number of connections.

These and other objects and advantages of the invention shall become apparent from the following general and preferred description of the invention.

The invention provides systems and methods of using inter-applet communication to provide communication between a server processor and a client processor via a net infrastructure such as the Internet. The systems of the invention provide total virtual persistence at the client tier, thereby allowing a state to be maintained at a client tier independently of a server and a database tier. Application data remains persistent during an entire session, even when working with multiple webpages. Application data is kept closest to where it is needed, which reduces the load on the server tier and conserves bandwidth.

An Applet Agent operates in the browser of the client processor. The client processor has a data cache. A server agent operates in the server processor. The server agent is interconnected to a server database. The server database stores a plurality of Client Applets along with data associated with each Client Applet. The Applet Agent sends a request to the server agent for retrieval of a selected Client Applet. The server agent retrieves the selected Client Applet and the selected Client Applet's data from the server database, and the server agent sends the selected Client Applet and the selected Client Applet's data to the Applet Agent. The Applet Agent sends the selected Client Applet and the selected Client Applet's data to the browser of the client processor. The Applet Agent then stores the data of the selected Client Applet in the cache of the client processor, such that the selected Client Applet's data may be retrieved without accessing the server processor or the server database even after the selected Client Applet has been extinguished. The Applet Agent preferably stores the selected Client Applet in the cache of the client processor, such that the Client Applet may be re-spawned on the client browser without accessing the server processor or the server database even after the selected Client Applet has been extinguished, and such that the re-spawned Client Applet may be re-populated with the data cached in the client processor without accessing the server processor.

When a Client Applet is no longer needed, it is extinguished from the browser of the client processor. When a Client Applet is extinguished, the Applet Agent sends a request to the server agent for retrieval of a second selected Client Applet. The server agent retrieves the second selected Client Applet and the second selected Client Applet's data from the server database, and the server agent sends the second selected Client Applet and the second selected Client Applet's data to the Applet Agent. The Applet Agent sends the second selected Client Applet and the second selected Client Applet's data to the browser of the client processor. The Applet Agent then retrieves the data of the selected Client Applet from the cache and populates the second selected Client Applet with at least some of the data of the selected Client Applet. The Applet Agent stores the data of the second selected Client Applet in the cache of the client processor, such that the second selected Client Applet's data may be retrieved without accessing the server processor or the server database even after the second selected Client Applet has been extinguished. Upon the conclusion of a session, the Applet Agent retrieves the cached data for the selected Client Applets from the cache, the Applet Agent sends the cached data to the server agent, and the server agent sends the cached data to the server database for storage.

During a session, the user may input new data into the selected Client Applets. The Applet Agent stores the input data in the cache of the client processor, such that each Client Applet's data may be retrieved without accessing the server processor or the server database even after selected Client Applets have been extinguished.

When a user inputs new data into the selected Client Applet, the new data is registered with the Applet Agent. In a preferred embodiment, the step of registering the new data with the Applet Agent comprises the Client Applet instructing the Applet Agent to retrieve the new data from the Client Applet; the Client Applet instructing the Applet Agent to register the new data; and the Client Applet instructing the Applet Agent to take a snap shot of the new data.

When a user is finished with the Client Applet, a log off message is sent to the Applet Agent, and the Client Applet is then extinguished from the client browser. The Applet Agent then sends the new data for the extinguished Client Applet to the application server database for storage. In a preferred embodiment, the step of sending new data for the extinguished Client Applet to the application server database for storage comprises: the Client Applet sending a submit message to the Applet Agent; the Applet Agent submitting the Client Applet's data to the application server agent, and the application server agent sending the Client Applet's data to the database server for storage.

When a user is finished with the Applet Agent, a log off message is sent to the application server agent via the Applet Agent, and the application server agent then logs off the Applet Agent.

The foregoing functions can be carried out for a plurality of Client Applets, with the Client Applets sequenced into a logical unit of work. By arranging a plurality of the Client Applets into a logical unit of work, a finite set of the Client Applets can be used to accomplish multiple functions. One of the Client Applets is preferably a Menu Applet. The Menu Applet is configured to allow for selection of Client Applets. A sequence leader is used to determine which of the Client Applets will be used in a logical unit of work, and the order in which the Client Applets will be used in the logical unit of work. A second Client Applet is then retrieved to replace the logged out Client Applet, with the second Client Applet being retrieved in accordance with instructions from the sequence leader for a logical unit of work. The step of retrieving a second Client Applet preferably comprises: sending an addApplet message and a getSnapShot message to the Applet Agent; the Applet Agent retrieving the new Client Applet and its snapshot data from the application server database; the Applet Agent spawning the new Client Applet on a browser of the client processor, and the Applet Agent populating the new Client Applet with pertinent data from one or more of the extinguished Client Applets. The Applet Agent then populates the new Client Applet with data received from the application server database via the application server agent.

The steps of initializing new Client Applets, inputting data into the Client Applets, and storing the input data to the Applet Agent are repeated until all Client Applets in a logical unit of work have been accessed. At the conclusion of the logical sequence of work, the Applet Agent sends data from the Client Applets to the application server database for storage. In a preferred embodiment, the step of sending the data to the database comprises: a user inputting a Submit function at a last Client Applet in the logical unit of work; upon receiving the input, the last Client Applet in the logical unit of work sending a submit message to the Applet Agent; upon receiving the submit message, the Applet Agent submitting the data of the Client Applets in the logical unit of work to the application server agent, and the application server agent sending the data of the Client Applets in the logical unit of work to the application server database for storage.

The methods of the invention serve to provide a secure network connection between a client processor and an application server processor. After an Applet Agent is spawned on the client processor, the Applet Agent initiates a client connect with the server agent. The connection consists of a dynamic, random port that is used only for one session. The connection between the Applet Agent and the server agent serves as the exclusive connection between the client processor and the application server during the session, which provides virtually fail-safe security. To further enhance security, data exchanged between the client processor and the application server may be encrypted.

The systems and methods of the invention can also be used to provide a novel graphical user interface for a web browser that can be used to select from a menu on the browser display. An Applet Agent is displayed on a web-page on the browser, the Applet Agent being interconnected to a server agent of a server processor in the manner described above. A Menu Applet is displayed on the webpage on the browser simultaneously with the Applet Agent. As described above, the Menu Applet provides options for selecting among logical units of work, with each logical unit of work consisting of a plurality of the Client Applets. The user uses the Menu Applet to select a logical unit of work. In response to the input, the Menu Applet sends the selection to the Applet Agent. The Applet Agent then sends the selection to the server agent. The server agent retrieves a first Client Applet in the logical unit of work and the first Client Applet's data from the server database. The server agent sends the first Client Applet and the first Client Applet's data to the Applet Agent. The Applet Agent caches the first Client Applet and the first Client Applet's data, and the Applet Agent displays the Client Applet on the web-page on the browser simultaneously with the Applet Agent and the Menu Applet. Data is updated in the cache based on input from the user, and Client Applets are retrieved and replaced until the logical unit of work is completed.

### BRIEF DESCRIPTION OF THE DRAWINGS

FIG. 1 is a uniform modeling language flow chart showing an overview of an Internet based system for utilizing the inter-applet communication system of the invention.

FIG. 2 is a uniform modeling language flow chart showing an overview of one preferred embodiment of the inter-applet communication system of the invention.

FIG. 3 is a uniform modeling language flow chart showing communication of multiple Client Applets via an Applet Agent, according to the system of the invention.

FIG. 4A is a uniform modeling language flow chart showing a preferred set of applets for use in an administrative application of the inter-applet communication system of the invention.

FIG. 4B is a block diagram showing a preferred set of applets for use in an administrative application of the inter-applet communication system of the invention, demonstrating sequential use and reuse of Client Applets.

FIG. 5 is a flow chart showing an overview of the inter-applet communication system of the invention, demonstrating communication between client side processes and server side processes.

FIG. 6 is a flow chart showing how the Applet Agent serves as an intermediary between the database and a user interface in the inter-applet communication system of the invention.

FIG. 7 is a flow chart showing an overview of a web server used in the inter-applet communication system of the invention.

FIG. 8 is a flow chart showing communication between Client Applets and an Applet Agent according to the inter-applet communication system of the invention.

FIG. 9 is a preferred embodiment of a graphical user interface of an administrative system using the inter-applet communication system of the invention.

FIGS. 10A-F are preferred embodiments of graphical user interfaces of web pages in an administrative system using the inter-applet communication system of the invention, demonstrating sequential use of selected Client Applets.

### PREFERRED EMBODIMENTS OF THE INVENTION

In the following detailed description of the preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

### Overview of the Inter-Applet Communication System

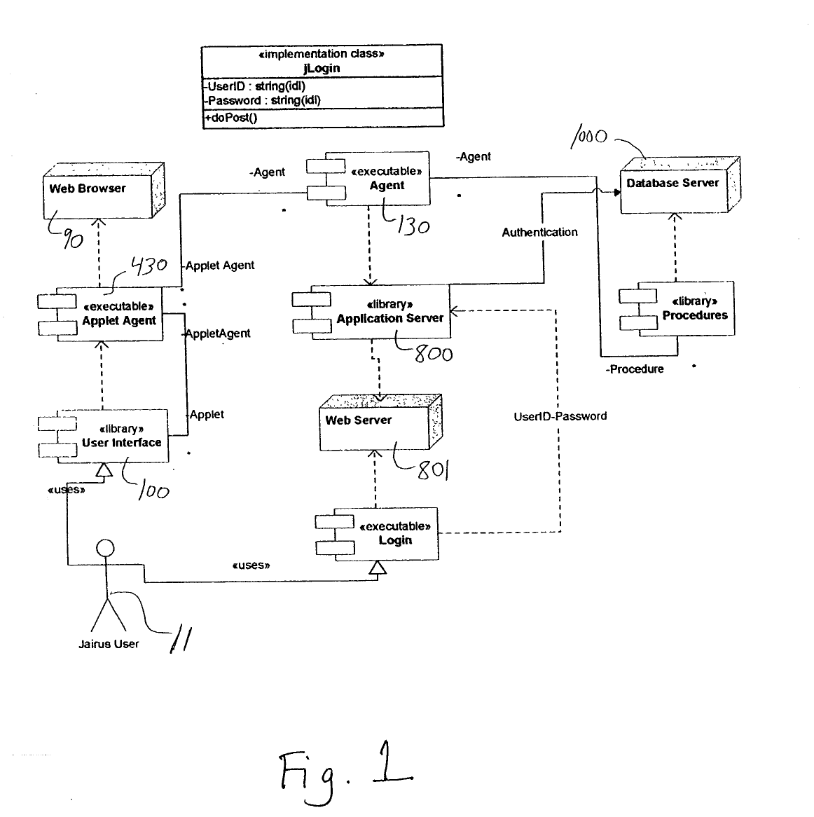

FIG. 1 provides a broad overview of the logical components that are used in the system of the invention. As shown in FIG. 1, the invention is used on conventional Internet web-site platforms. A user 11 accesses and uses the system via a processor, such as a personal computer (PC). The functions of the system are performed via a web interface where a user or client comes to the inter-applet communication system of the invention site using a browser such as Internet Explorer 5.0 or Navigator 4.x, which operates on the processor of the user 11. A processor, such as a P.C. or mainframe, serves as the web server or host server 801. The host server 801 is programmed to carry out the functions described in further detail below. These programmed functions include an application server 800. A database server 1000 is associated with the host server 801. The host server 801 is connected to the Internet via a means known in the art, such as through a modem to a telephone or ISDN line. A user/client 11 logs onto the host server 801 via the Internet, typically through a conventional Internet service provider (ISP). The user 11 logs onto the host server 801 using a user identification number/user ID and a password, but uses a unique secure network connection (described in further detail below). Once the user 11 is logged onto the host server 801, the user 11 can use the inter-applet communication system of the invention in the manner described below. Each Java applet that is opened on the user's processor has a Java Virtual Machine (“JVM”) working in the background. Java does not have access to the client's processor. Java only has access to the JVM, which exists only in the computer's memory. The system of the invention creates a class in the JVM that notifies the applet that other applets exist.

The inventive program routines described below provide the user with numerous options for selecting and using applets. The user interfaces of the invention employ conventional point-and-click display and selection components, such as the type presently used on the Microsoft Windows and Macintosh operating systems. The system can also be configured such that a user or client with a mobile device such as a cell phone, a pager, or PDA can log on to the server through a wireless network using a user ID and password. In this case, the host server 801 provides desired information in a format suitable to the client's mobile device. Additionally, although the following discussion is based on Internet applications, it will be appreciated that the system can be used on any web-based application, whether internal (intranet) or external (Internet).

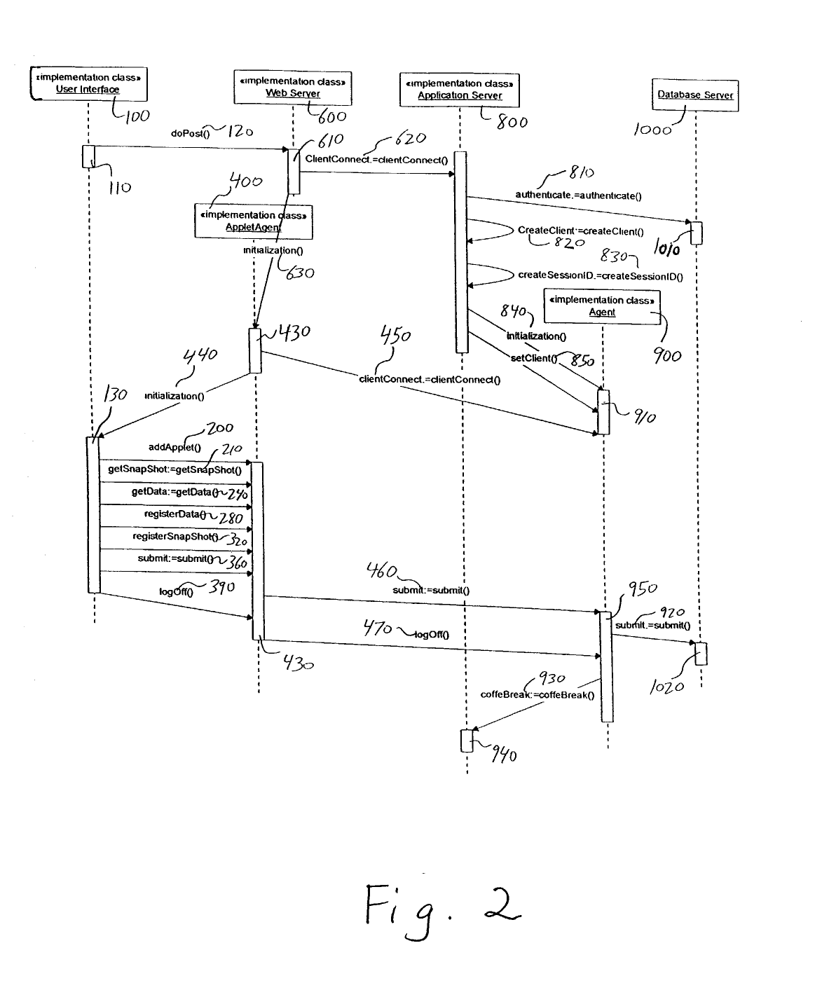

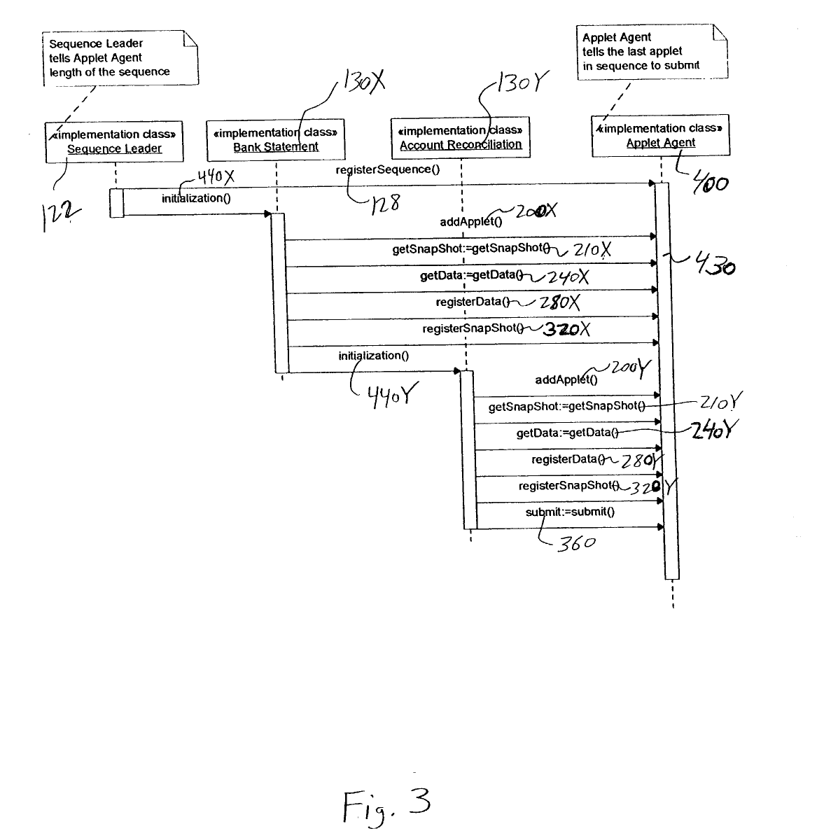

FIG. 2 provides an overview of the system in the form of Uniform Modeling Language flowcharts. Each vertical line in the chart represents an instance or life line signifying a particular operation of the system. The user interface 100 instance includes operations that occur on a client processor. At step 110, a user sends a login request to the web server 600 via a doPost 120 command. At step 610, the web server 600, upon receiving the login request, executes a clientConnect 620 command. In instance 800, the application server initiates a login procedure. The application server 800 executes an authenticate 810 command to the database server 1000. At step 1010, the system pulls the user's login criteria from the database server 1000 and forwards the user's login criteria to the application server 800. If the login information entered by the user matches the user's login information in the database 1000, the application server creates a client 820, creates a session 830, initializes an agent 840, and sets the client 850 (i.e. tells the agent 840 to the take care of this particular client).

As shown in FIG. 2, the system of the invention uses a plurality of applets that run at the same time. One applet, designated the “Applet Agent” 130, runs continuously and is always connected to the host server via the agent 900. The Applet Agent 430 serves as the sole communication link between the client processor and the host server. The other applets, designated “Client Applets” 130, communicate with the Applet Agent 430. In one preferred embodiment of the invention, one of the Client Applets 130 is a “Menu Applet” 129. The Applet Agent 430 stays alive as long as the browser window is up and running on the client's processor. Once the user closes the browser window, the Applet Agent 430 and all of its data, including Client Applets 130, is extinguished.

As shown in FIG. 2, the web server 600 initializes the Applet Agent 430 at step 630. Once initialized, the Applet Agent 430 initiates a client connect 450 with the agent 900. The establishment of the connection 450 with the agent 900 is an important part of the security features of the invention. The connection 450 between the Applet Agent 430 and the application server agent 900 provides a secure connection between the client's processor and the host server processor. The connection 450 is a dynamic, random port that is used only for one session. When sending port and session information during establishment of a connection between the client processor and the host processor/server, the port and session information is random and is good only while that particular session is running. This feature provides a virtually impenetrable level of security. Even if a third party hacker obtains all of the available applets, the third party will still be unable to connect to the port.

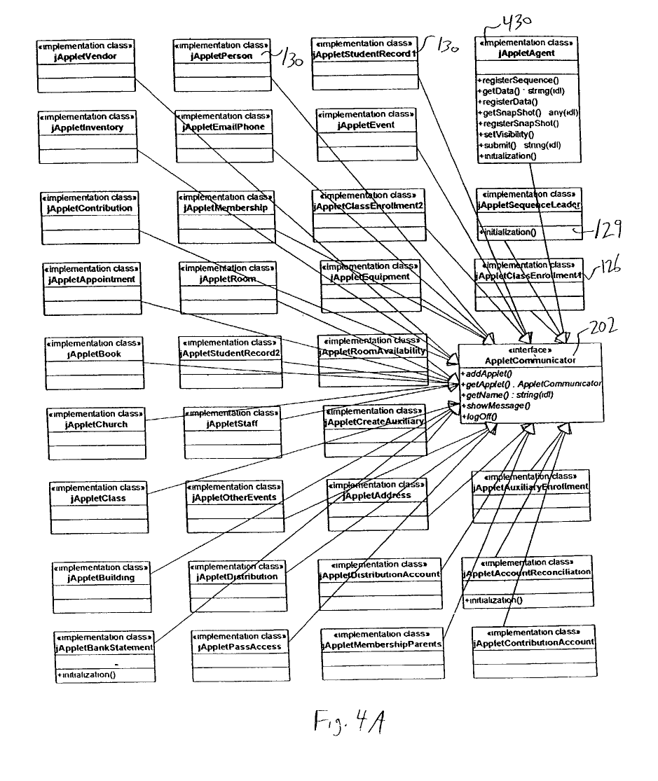

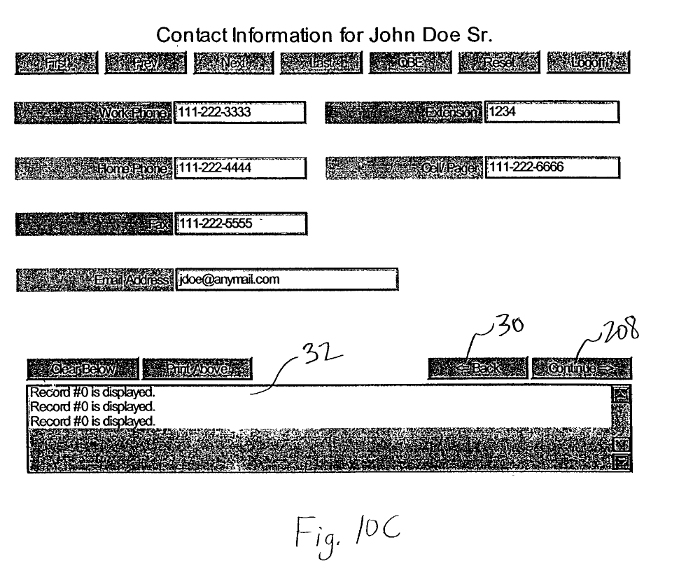

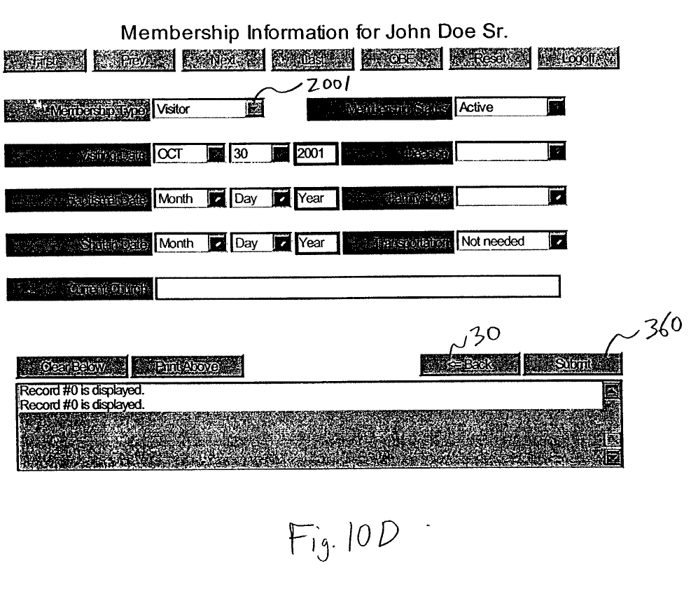

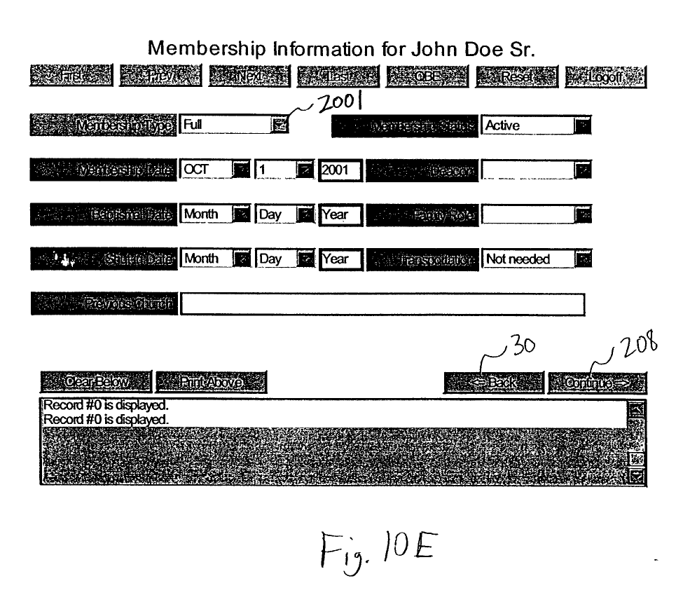

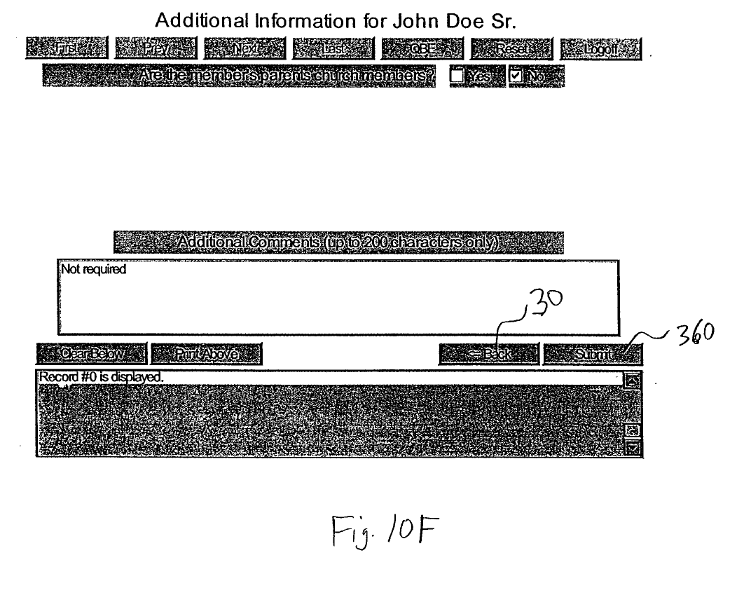

The Client Applets 130 are used and run by the client processor. When a client selects 110 a particular Client Applet 130 (or selects a protocol that requires a particular Client Applet 130), the Applet Agent 430 initializes 440 the selected or necessary Client Applet 130. The Client Applets 130 will typically be selected based on their applicability to the particular type of function or service that is provided by the host server. For example, in a data administration system using the inter-applet communication system of the invention, the Client Applet 130 might provide a web frame consisting of a data entry template (see e.g. FIG. 10). The number of Client Applets 130 available will vary considerably depending on the particular function or service that is provided by the host server. All of the Client Applets 130 directly communicate only with the Applet Agent 430. The Client Applets 130 do not communicate directly with each other or with the application server 800. The Client Applets 130 communicate with one another indirectly by sending messages to the Applet Agent 430, as shown particularly in FIGS. 3 and 8. The Applet Agent 430 is analogous to a message depot. The Applet Agent 430 also communicates with the Agent 900 that is resident in the application server 800. The agent 900 communicates with the database server 1000, retrieving information from or storing information to the database as needed. When a new Client Applet 130 is initialized 440 by the Applet Agent 430, the new Client Applet 130 receives pertinent data from the Applet Agent 430. This data will typically consist of or include data from one or more Client Applets 130 that have been extinguished from the client processor. The data may also include data that the Applet Agent 430 received from the agent 900.

Steps 200-390 of FIG. 2 illustrate a preferred embodiment for inter-applet communication according to the invention. When a user, through operation of the client processor browser, selects a new Client Applet 130, an addApplet message 200 and a getSnapShot message 210 are submitted 360 to the Applet Agent 430. The snap shot may include data that has previously been entered into the selected new Client Applet 130 (entry of the snap shot data into the Client Applet 130 is typically done by the user of the client processor, in a manner described in further detail below. See e.g FIG. 10). At step 460, the Applet Agent 430 submits a request for the new applet and the snapshot data directly to the agent 900 on the application server 800. At step 950, the agent 900 submits 920 the add applet message to the database server 1000. The selected Client Applet 130 and its snapshot data (if available) are retrieved from the database 1020. The new Client Applet 130 and its snapshot data are transmitted to the application server agent 900. The application server agent 900 then transmits the new Client Applet 130 and its snapshot data to the Applet Agent 430. The Applet Agent 430 then in turn transmits the new Client Applet 130 and its snapshot data to the web browser of the client processor.

Once the Client Applet 130 and its snapshot data are on the browser of the client processor, the Client Applet 130 can be operated via the JVM of the browser. For example, if the Client Applet 130 includes a template for entering data, the template will be displayed in a frame or window of the client processor (see e.g. FIGS. 9 and 10). During operation, the user may enter additional data into the Client Applet 130. After the user has entered data into the Client Applet 130, the new data can be registered with the Applet Agent 430. At step 240, the Client Applet 130 instructs the Applet Agent 430 to retrieve the new data from the Client Applet 130. At step 280, the Client Applet 130 instructs the Applet Agent 430 to register the new data. At step 320, the Client Applet 130 instructs the Applet Agent 430 to take a snap shot of the data. As will be described below, the foregoing functions can be carried out for a plurality of client applets 130, with the applets 130 sequenced into a logical unit of work.

When a user is finished with a particular Client Applet 130, a log off message 390 is sent to the Applet Agent 430. After the Client Applet 130 logs off, the Client Applet 130 is destroyed from the memory of the client processor. However, the Applet Agent 430 remains alive on the client processor, and the Applet Agent 430 retains the data that was registered in the Applet Agent 430 via the snap shot functions described above. In this manner, data from an extinguished Client Applet 130 can be used with a subsequent live Client Applet 130 by retrieving the data from the Applet Agent 430, in a manner described below.

At certain stages of use of the system, data from the client applets 130 is sent to the database 1000 for storage. In FIG. 2, this process is demonstrated at step 360, in which the Client Applet 130 sends a submit message, whereupon the Client Applet's 130 data is sent to the Applet Agent 430. At step 460, the Applet Agent 430 submits the Client Applet 130's data to the application server agent 900. The application server agent 900 in turn sends the Client Applet's 130 data to the database server 1000 for storage.

When a user is finished with the Applet Agent 430, a log off message 470 is sent to the application server agent 900, which in turn logs off the Applet Agent 430. The agent 900 determines whether the Applet Agent 430 logs off. Once the Applet Agent 430 logs off, the Client Applets 130 can no longer communicate with one another. As shown in FIG. 2, when the agent 900 is not receiving a submission 460 or a logoff message 470, the agent 900 goes on a coffee break 930.

### Logical Units of Work

One feature of the invention is the ability to selectively arrange a sequence of Client Applets 130 into a logical unit of work. By arranging Client Applets 130 into logical units of work, a finite set of Client Applets 130 can be used to accomplish multiple tasks. A particular Client Applet 130 can be used and reused in several different logical units of work.

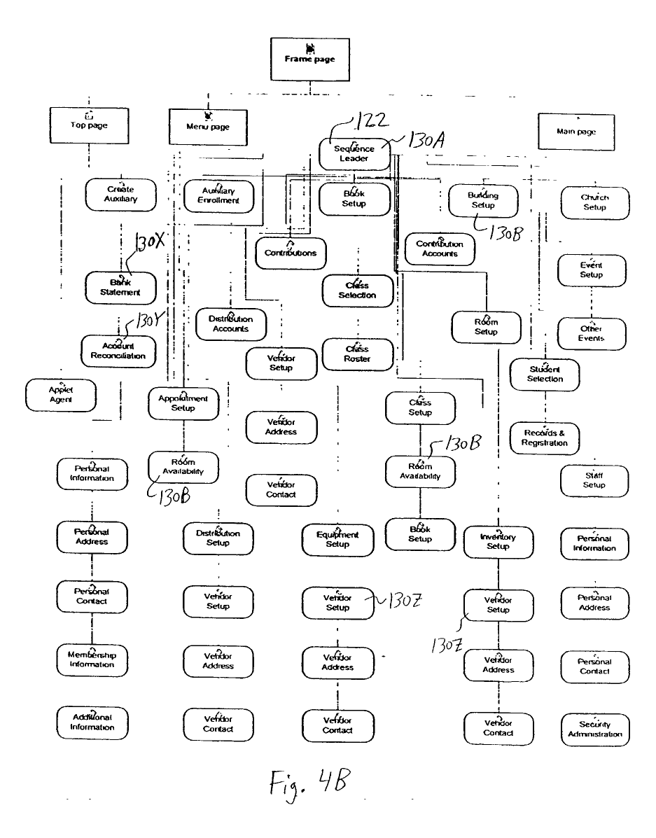

FIG. 4A shows a finite set of Client Applets 130 that have been selected for use in an administrative application of the inter-applet communication system of the invention. As shown in FIG. 4A, each of the Client Applets 130 communicates only with the Applet Agent 430. Communication between Client Applets 130 and the Applet Agent 430 is accomplished by an applet communicator function 202, which carries out the functions discussed above. FIG. 4A also shows an applet sequence leader 122. Each logical unit of work has a particular sequence leader 122. The sequence leaders 122 determine the sequence in which a plurality of client applets 130 will be accessed during a particular logical unit of work. The sequence 122 leader also determines when the last screen is reached in a logical unit of work, at which point the last Client Applet 130 in the logical unit of work provides a “Submit” option.

FIG. 4B shows a set of selected applets arranged in a plurality of logical units of work. For example, if a user selected a financial statement function, the sequence leader 122 would select the following sequence of Client Applets: 1. Bank Statement Client Applet 130X; and 2. Account Reconciliation Client Applet 130Y. Note that some of the Client Applets, such as Vendor Setup 130Z, are used in multiple logical units of work. When setting up logical units of work, Client Applets 130 may be arranged in strictly linear sequences. Additionally, Client Applets 130 may be arranged in branched sequences, such that input at a fork in the sequence selects between alternative paths of Client Applet sequences.

FIG. 3 shows the fundamental means of communication between applets in a logical unit of work according to the teaching of the invention. As mentioned above, the Client Applets 130 are used and run by the client processor. When a client selects 110 a particular function, the sequence leader 122 for that function determines which Client Applets 130 will be used in the logical unit of work, and typically determines what order the Client Applets 130 will be used in. The Applet Agent 430 initializes 440 the first Client Applet 130. In FIG. 3, the first Client Applet is Bank Statement Client Applet 130X.

As shown in FIG. 3, when a user, through operation of the client processor browser, selects a new Client Applet 130X, an addApplet message 200X and a getSnapShot message 210X are submitted to the Applet Agent 430. The Applet Agent then retrieves the new Client Applet 130X and its snapshot data from the database 1020 in the manner described above with reference to FIG. 2. The new Client Applet 130X is then used and/or displayed on the web browser of the client's processor. During operation, the user may enter additional data into the Client Applet 130X. After the user has entered data into the Client Applet 130X, the new data can be registered with the Applet Agent 430. At step 240X, the Client Applet 130X instructs the Applet Agent 430 to retrieve the new data from the Client Applet 130. At step 280X, the Client Applet 130X instructs the Applet Agent 430 to register the new data. At step 320X, the Client Applet 130X instructs the Applet Agent 430 to take a snap shot of the data. The first Client Applet 130X then logs off. As mentioned above, after the Client Applet 130 logs off, the Client Applet 130 is destroyed from the memory of the client processor. However, the Applet Agent 430 remains alive on the client processor, and the Applet Agent 430 retains the data that was registered in the Applet Agent 430 via the snap shot functions described above. In this manner, data from an extinguished Client Applet 130 can be used with a subsequent live Client Applet 130 by retrieving the data from the Applet Agent 430, in a manner described below.

As indicted in FIG. 3, after the first Client Applet 130X logs off, the system then retrieves the second Client Applet in the logical sequence, which in FIG. 3 is designated Client Applet 130Y. An addApplet message 200Y and a getSnapShot message 210Y are submitted to the Applet Agent 430. The Applet Agent then retrieves the new Client Applet 130Y and its snapshot data from the database 1020 in the manner described above with reference to FIG. 2. The new Client Applet 130Y is then used and/or displayed on the web browser of the client's processor. As mentioned above, the Client Applets 130 directly communicate only with the Applet Agent 430. When a new Client Applet 130Y is initialized 440 by the Applet Agent 430, the new Client Applet 130Y receives pertinent data from the Applet Agent 430. This data will typically consist of or include data from one or more Client Applets 130X that have been extinguished from the client processor. The data may also include data that the Applet Agent 430 received from the agent 900. During operation, the user may enter additional data into the new Client Applet 130Y. After the user has entered data into the Client Applet 130Y, the new data can be registered with the Applet Agent 430. At step 240Y, the Client Applet 130X instructs the Applet Agent 430 to retrieve the new data from the Client Applet 130. At step 280Y, the Client Applet 130Y instructs the Applet Agent 430 to register the new data. At step 320Y, the Client Applet 130Y instructs the Applet Agent 430 to take a snap shot of the data.

The foregoing steps of initializing new Client Applets 130, inputing data into the Client Applets 130, and storing the input data to the Applet Agent 430 are repeated until all Client Applets in the logical unit of work have been accessed. At the conclusion of a logical sequence of work, data from the client applets 130 is sent to the database 1000 for storage. In FIG. 3, this process is demonstrated at step 360, in which the last Client Applet 130Y in the logical unit of work sends a submit message 360 (which is typically activated by input from the user), whereupon the Client Applet's 130 data is sent to the Applet Agent 430. As shown in FIG. 2, at step 460 the Applet Agent 430 submits the data of the Client Applets 130 to the application server agent 900. The application server agent 900 in turn sends the Client Applets 130 data to the database server 1000 for storage.

As shown in FIG. 9, one of the client applets 130 is preferably a Menu Applet 129. The Menu Applet 129 can be a standard applet, such as the type available from Apycom.com (see www.apycom.com). As shown in FIG. 9, by clicking on selected menu options from the Menu Applet 129 in frame 2, the client calls up selected Client Applets 130. Once a Client Applet 130 is called up, it communicates with the host server only via the Applet Agent 430. These features enable a rich environment, with many pop up screens and selectable options.

The invention preferably uses a one-hundred percent java based protocol for inter-applet communication. Java server pages (JSP) or HTML screens can duplicate the functionality of the present invention, but at a much greater cost because every time the client user changes data, the change has to be sent back to the database for approval. The system of the invention carries out all data changes on the same client processor, and therefore can incorporate enormous amounts of functionality that operate on the local client processor. For example, the system of the invention can run fifty applets on one page with only one connection to the host server. This is an extremely efficient mode of operation.

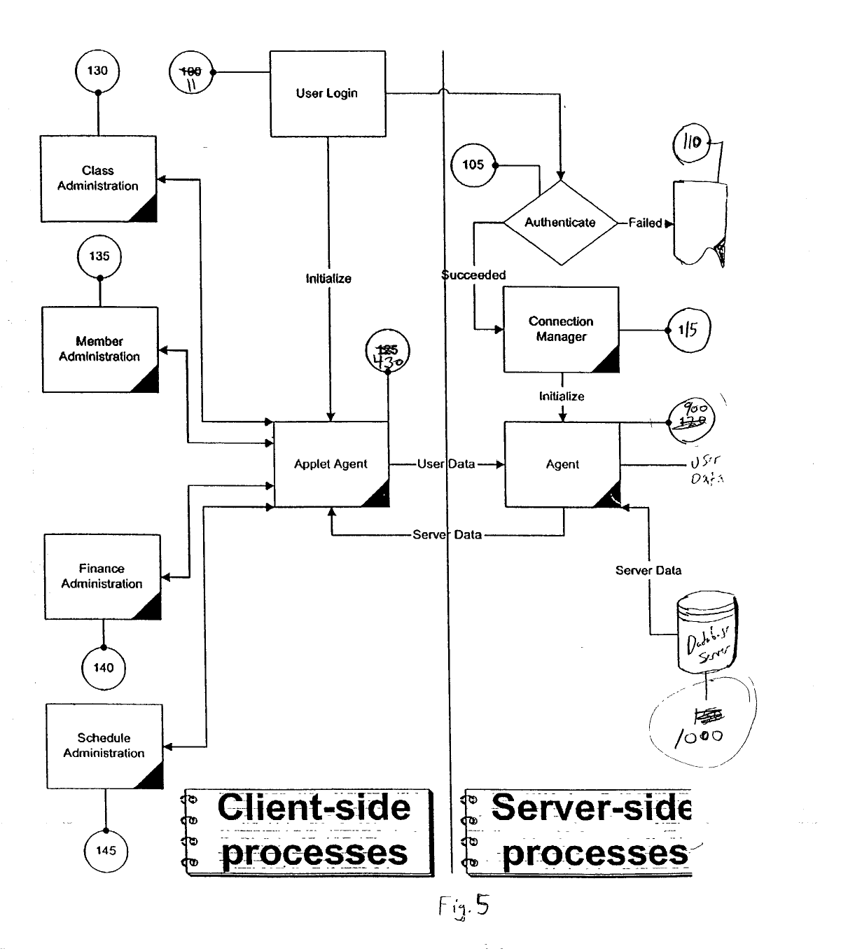

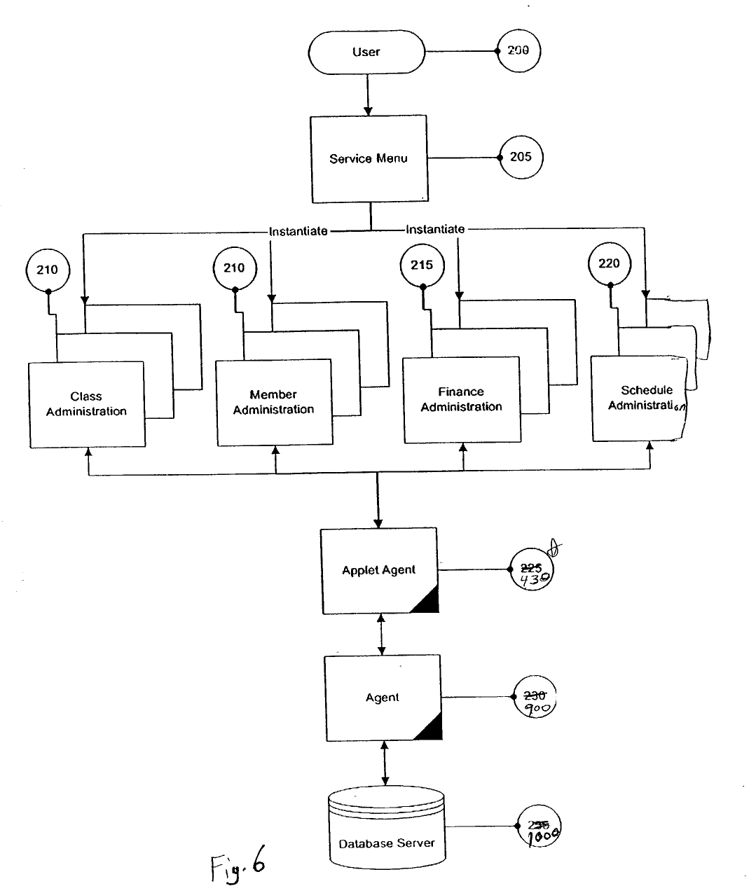

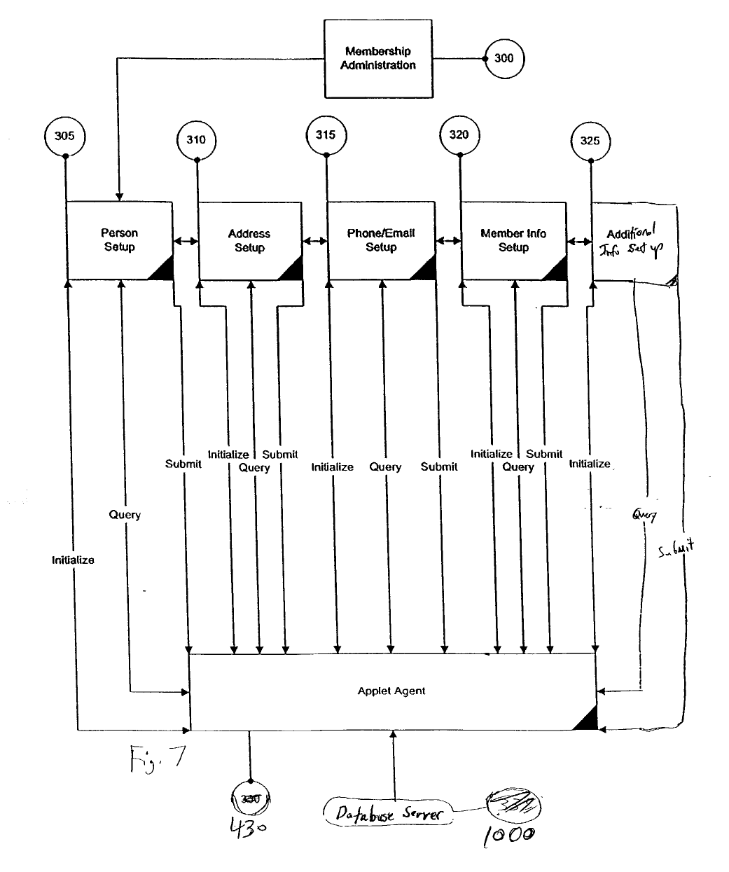

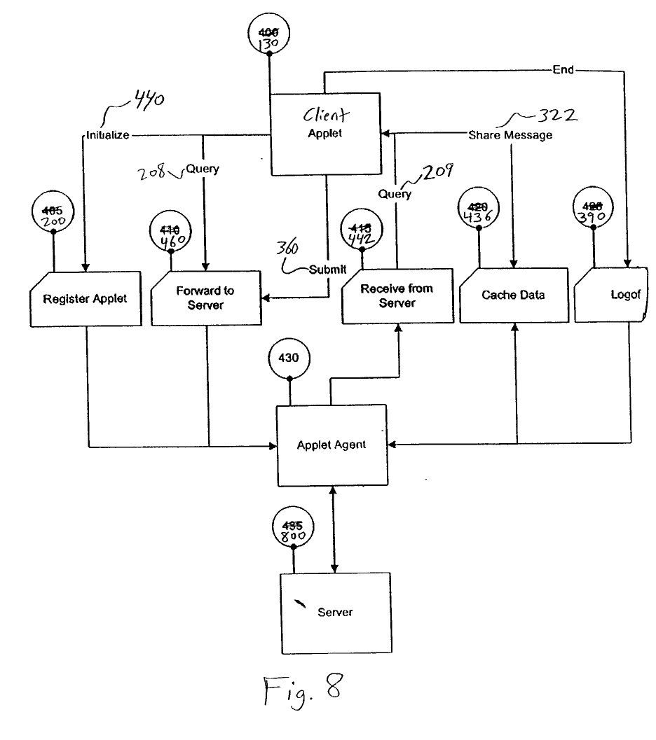

FIG. 5 illustrates how the user 11 logs into the system and how the system allows the Applet Agent 430 (Client Side Components) to establish a connection to the server agent 900 (Server Side Components). The user 11 inputs the user ID and password necessary for the system to authenticate the User 11 into a standard HTML page and triggers a “submit” event. This event causes two actions to be taken. First, a servlet is initiated on the application sever whose purpose is to Authenticate 105 the User 11, establish a session and assign a port number. Secondly, the “Submit” event spawns another HTML Page with frames to the client machine. The Applet Agent 430 is initialized on the client machine but is un-instantiated. If the user 11 is authenticated 105, the servlet sends a message to the Connection Manager 115 requesting that a connection be established with the specified session on the given port number. The Connection Manager 115 initializes the Agent 900 that has an established connection to the Database Server 1000. The server agent 900 will service only the Applet Agent 430 with the specified session and port number. The session and port number are only valid while the browser is open or until the session is terminated by the User 11. If the Authentication 105 fails, the servlet will simply return a default HTML page specifying to the User 11 that the authentication process has failed and the process has ended.

FIG. 6 illustrates the interaction between the User 11, the Service Menu 205, the Applet Agent 255, the server agent 900, and the database server 1000 to initiate the Logical Unit of Work (210 thru 220) required by the User 11. The User 11 specifies that Class Administration 210 is to be performed by choosing the proper menu item from the Service Menu 205. The service menu 205 sends a message to the Applet Agent requesting the instantiation of the proper lead applet for the Class Administration 210 workflow. The Applet Agent 430 sends a message to the server agent 900 requesting the first applet along with the necessary data required for initialization of the workflow. The server agent 900 retrieves the specified applet and sends a message to the database server 1000 requesting the data required to support the initial operation of said applet. Once the database server 1000 has retrieved the corresponding data, it returns the record set to the server agent 900. The server agent 900 synchronizes the data with the applet and returns both to the Applet Agent 430. The Applet Agent 430 registers the sequence and instantiates the applet along with the corresponding data and the User 11 begins the logical unit of work. The same process is followed regardless of which unit of work is chosen by the User 11.

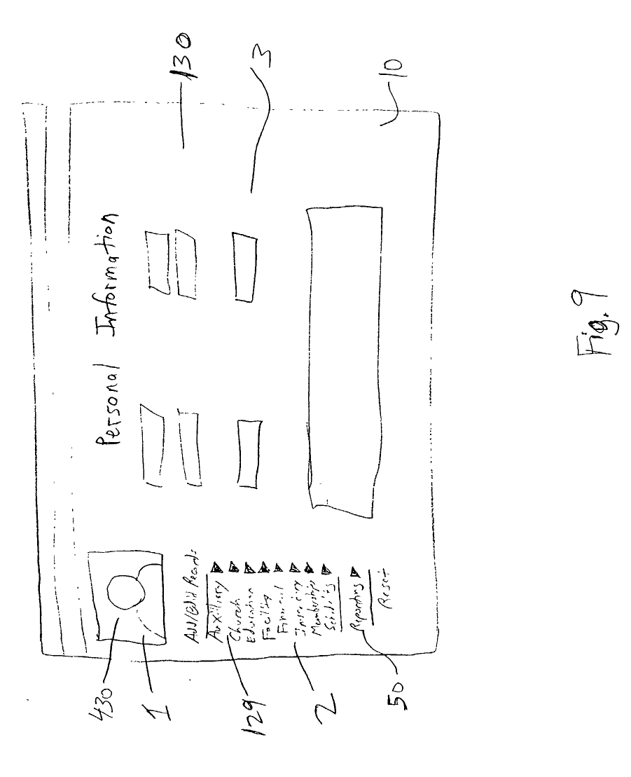

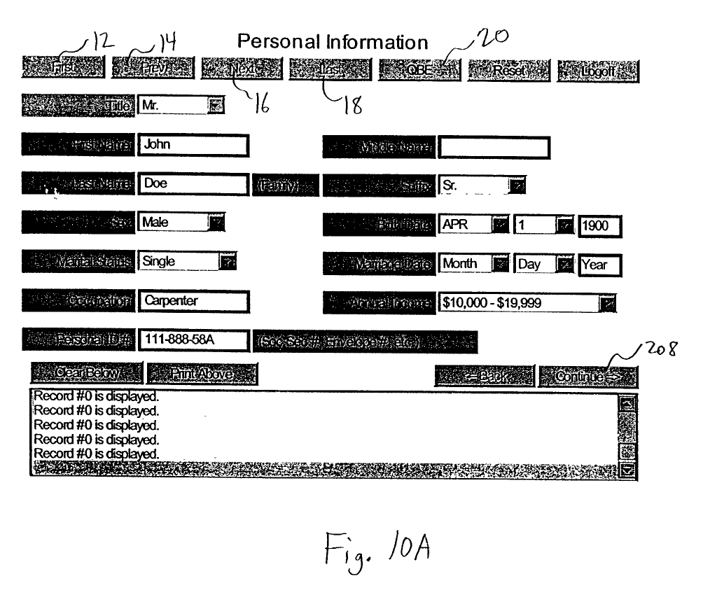

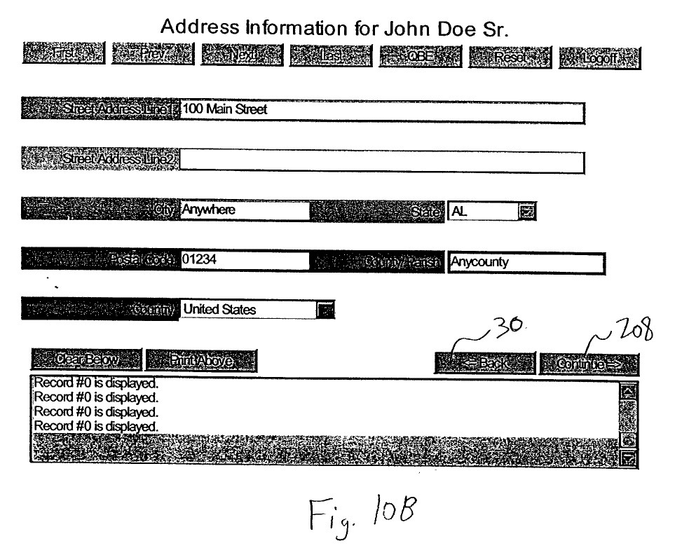

FIG. 7 illustrates the interaction of Client Applets (305 thru 325), the Applet Agent 430, and the data used by the Client Applets (305 thru 325) during the execution of a logical unit of work. The process begins when the user selects membership administration 300 from the menu applet (See FIG. 9). This action notifies the Applet Agent 430 of the first client applet, Person Setup 305, to be spawned for the pending logical unit of work to be performed by the user. The Applet agent 430 initializes the Person Setup Applet 305, submits any Query required by the Person Setup Applet 305 for initial processing by the user, and waits for the user to trigger an event (Submit) signaling the completion of the required task specified in the Person Setup Applet 305. The Applet agent 430 stores the user-supplied data, and the next client applet Address Setup 310 is spawned. The Applet agent 430 initializes the Address Setup Applet 310, submits any Query required by the Address Setup Applet 310 for initial processing by the user, and waits for the user to trigger an event (Submit) signaling the completion of the required task specified in the Address Setup Applet 310. The Applet agent 430 stores the user-supplied data, and the next client applet Phone/Email Setup 315 is spawned. This process continues until the logical unit of work is completed, at which point the Applet agent 430 sends the completed record set to the server for storage in the Database server 1000. However, if prior to the event signaling the completion of the logical unit of work, the user decides to traverse backwards through the sequence of Client Applets (325 thru 305), the applet is simply spawned from the cache of the Client Machine and initialized with the data stored by the Applet agent 430. There is no need to retrieve additional information from the database server 1000.

FIG. 8 is a flow chart showing an internal view of communication between Client Applets 130 and an Applet Agent 430 according to the inter-applet communication system of the invention. FIG. 8 shows the processes that occur within the Applet Agent 430 during inter-applet communication. A Client Applet 130 or a sequence of Client Applets 130 are selected by a user operating a client processor. At the Client Applet initialization step 440, the sequence leader 128 sends a message to the Applet Agent 430 telling the Applet Agent 430 which Client Applets 130 or series of Client Applets 130 are needed. At this point, the Applet Agent 430 retrieves only the first Client Applet 130 in the sequence. However, once the first Client Applet 130 has been retrieved from the server and its task has been performed, a copy of the first Client Applet 130 is stored in the cache of the local client machine (i.e the Client Applet is registered). If the first Client Applet 130 is needed again after it has been extinguished, the Applet Agent 430 does not have to request the applet again from the server 800. Instead, the Applet Agent 430 simply pulls the Client Applet 130 from the local machine cache, in a manner described below.

At step 200, the Applet Agent 430 begins the process of registering a Client Applet or Applets 130. The Applet Agent 430 communicates with the server 800 through the application server agent 900 and downloads the first Client Applet 130. At step 442, the Applet Agent 430 receives the Client Applet 130 and its data from the application server 800. The Applet Agent 430 then registers the Client Applet 130 and displays the first Client Applet 130 on the screen of the client's processor, along with the recorded data that is associated with that particular Client Applet 130. The Applet Agent also caches the data 436 needed by the active Client Applet 130. In some situations, the Applet Agent 430 also caches the data that will be needed by each Client Applet 130 during performance of a logical unit of work. For example, during completion of a logical unit of work, the user may be required to choose an item from a dropdown list 2001 (see FIG. 10D). The data required to populate the dropdown list 2001 is retrieved from the data base server 800 the first time that a new applet is spawned. This allows for the most current list at the time of execution. Once the user selects an item in the list, that item is stored into a hash table by the Applet Agent 430. If the Client Applet 130 is extinguished and then spawned again within the same logical unit of work, the list for that particular Client Applet 130 is re-populated as noted above and the specific item previously stored by the Applet Agent 430 is flagged. For example, when a user toggles between a “continue” key and a “back” key, the user is switching back and forth between Client Applets 130 (see FIG. 10). The data cache 436 serves as a master set of data that is needed while performing a logical unit of work. All of the data stored in the data cache 436 may not be needed by each particular Client Applet 130.

Once the Client Applet 130 is operational on the client's processor, the Applet Agent 430 waits for input of information from the client user. When a Client Applet 130 is displayed on a screen of a user's processor, the user may change the data associated with that particular Client Applet 130. For example, if the Client Applet 130 records and displays address information for an individual member of an organization, the user might erase the recorded street address and replace it with a new street address. When the user is finished entering and/or changing data, the user will hit an “enter” function, such as a “Continue,” “Next” or “Submit” button, at which point the modified data in the Client Applet 130 will be sent to the Applet Agent 430 for storage in the data cache 436. The “Continue” function signals the Applet Agent 430 to close out or extinguish the existing Client Applet 130 and replace it with a new Client Applet 130Y, in accordance with the sequence leader 122. The “Submit” function 360 is provided only at the conclusion of a logical unit of work. When the “Submit” function 360 is selected, the Applet Agent 430 updates the data cache 436 with the data from the last Client Applet 130 in the logical unit of work (i.e. records the data) and forwards the final data set for the logical unit of work to the server 800 via the application server agent 900. The data set is then stored in the database 1000 for future use.

Additionally, at step 208 the user may request a particular data set from the server 800. For example, if the user is updating address information for the members of an organization, the user might enter a query 208 to recover the address for a particular individual, e.g. “John Doe.” The Client Applet 130 receives the query 208 and forwards it to the Applet Agent 430. The Applet Agent 430 then forwards a message to the server 800 to retrieve the address and related information associated with “John Doe.” The server 800 retrieves the selected information and sends it to the Applet Agent 430, which receives the information 442. The Applet Agent 430 forwards 209 applicable components of the data to the Client Applet 130, and also stores the information for the member in the data cache 436. A user can then modify the data as described above. Because the data is cached 436 in the Applet Agent 430, the data can be copied to subsequent live Client Applets 130.

There are also instances in which the Client Applet 130 sends a query to the user prompting input of additional data. This will typically occur when a user attempts to close out a Client Applet 130 and move to a subsequent Client Applet 130, at which point the Client Applet 130 preferably checks whether all required data has been entered into the fields for that particular Client Applet 130. If one or more pieces of required data have not been entered, the Client Applet 130 will prompt the user to supply the missing data to the Client Applet 130 (this task could be performed by the Applet Agent 430, but it is preferably performed by the Client Applet 130 so as to reduce the size and complexity of the Applet Agent 430). For example, if the user entered an address for an individual, but forgot to enter the individual's zip code, the Client Applet 130 prompts the user to enter a zip code. Once the zip code or other required data is entered and the user subsequently selects an “enter” function (e.g. “Continue”), the Client Applet 130 sends a message to the Applet Agent 430, at which point the Applet Agent 430 updates the data in the data cache 436 and logs off 390 the Client Applet 130.

If the Applet Agent 430 is carrying out a logical unit of work, the Applet Agent 430 will call up the next Client Applet 130 in the series after a preceding Client Applet 130 has been destroyed. The next Client Applet 130 is selected according to the instructions from the sequence leader 122. As described above, the Applet Agent 430 loads the next Client Applet 130Y with appropriate data 322 from the data cache 436, which may include data that was input during operation of one or more preceding Client Applets 130; in this manner, the Client Applets 130 communicate with one another via the Applet Agent 430. As shown in FIG. 8, the Client Applets 130 do not communicate directly with the host server 800, but do communicate with the host server 800 indirectly through the Applet Agent 430.

The present invention employs MessageRelayer to implement many of the processes discussed above. MessageRelayer is a Java class that implements an applet communicator interface. The use of MessageRelayer in inter-applet communication is discussed in technique number 3 of Cozad's article, supra. Like Cozad, the present invention provides a one hundred percent Java solution that can run on any processor having a browser that supports Java. Unlike conventional MessageRelayer applet communication and the inter-applet communication technique described in Cozad's article, the present invention makes data persistent, so that the data can be accessed by multiple Client Applets 130, as discussed above. In technique number 3 of his article, Cozad discusses multiple applets on an HTML page communicating with one another. But after each applet is closed out or extinguished, it is destroyed from the processor's memory. Normally when HTML pages are created, each HTML page is different. The present invention improves over technique number 3 of Cozad by allowing applets to communicate across HTML frames of an HTML page. The invention creates an applet in one page and allows it to communicate across frames to any page. This technique can only be carried out via frames, because once an HTML page is closed, the applets on that page are removed and destroyed.

Application of the System to a Network Based Administrative Service

The inter-applet communication system of the invention can be incorporated into a number of useful Internet based computer systems. The system of the invention is particularly useful in Internet based administrative and database computer programs, where it becomes impractical and expensive to exchange large amounts of data between a client and server via the Internet. The following examples will describe use of the inter-applet communication system of the invention in an administrative program for religious institutions such as churches. It will be appreciated, however, that the invention can be used in virtually any application in which large amounts of data must be transferred and exchanged between clients and servers via a network, including the Internet or an intranet.

FIG. 9 is a preferred embodiment of a graphical user interface of an administrative system using the inter-applet communication system of the invention on a web browser. As shown in FIG. 9, the browser window can be divided into many smaller parts, or “frames.” On World Wide Web browsers, frames are defined areas that can act as multiple, separate browser windows within the same page. An HTML frame is a type of HTML page. Each frame is a separate window. The present invention works with either windows or frames. In the preferred embodiment shown in FIG. 9, the applets communicate across three HTML frames 1, 2, 3 on a single HTML page 10 of a web browser. In the embodiment of FIG. 9, the Applet Agent 430 in frame 1 and the Menu Applet 129 in frame 2 are held constant on the page 10. However, the Client Applet 130 in frame 3 changes depending on input received from the user of the system. Only one Client Applet 130 is displayed in frame 3. Client Applets 130 are repeatedly created and destroyed in frame 3, depending on user input. For many particular functions (i.e. logical units of work), a set of Client Applets are called up in a particular sequence. Except when working in a logical unit of work, any Client Applet 130 can be launched directly (rather than in sequence) at any time. The number of Client Applets 130 that can be used and displayed in the system of the invention is theoretically unlimited. Additionally, although only two Client Applets 129, 130 are displayed on the webpage of FIG. 9, it will be appreciated that many additional Client Applets 130 could be displayed on the webpage at the same time. The system of the invention provides a very dynamic application interface, because there is no set sequence of screens, except when carrying out a logical unit of work.

The HTML page 10 is associated with only one universal resource locator (“URL”)—i.e. as the content of the page 10 changes (i.e. as Client Applets 130 are extinguished and replaced), the URL remains the same. In conventional HTML web pages, the content and format of a page does not change during use (with the exception of updated data and information). When a conventional HTML page or frame is replaced with a different page or frame, the URL changes, because the frame or page is being drawn from a different URL address. Use of the inter-applet communication system of the invention with HTML pages allows for popup menus and other features that enrich the screen environment. For example, a conventional HTML page can provide multiple links to other web pages, but can provide only two input-output buttons. The use of the inter-applet communication system of the invention allows for more than two input-output buttons to be provided on an HTML page.

The inter-applet communication system can be used to provide a virtually unlimited number of functions/logical units of work, depending on the needs of the particular application. In the church administrative application embodiment shown in FIG. 9, the administrative system includes the following functions/logical units of work:

Auxiliary—Allows the institution to set up and administer boards, groups, clubs and the like.

Church—Records information about the church.

Education—Allows for scheduling of classes, class rooms, and the like.

Facility—Allows for scheduling of use of rooms, maintenance work and the like.

Financial—Tracks debits, credits, debts and related financial information.

Inventory—Tracks stocks of consumable goods.

Membership—Records personal and contact information about members of the church.

Scheduling—Allows for scheduling use of rooms and other resources of the church.

Reporting—Gathers information stored in the database and presents the information in the form of useable reports. Reporting is a key feature of the system, because it enables use of all of the information in the system, preferably in customized formats.

In the preferred embodiment shown in FIG. 9, each of these functions is accessed from a Menu Applet 129, which operates as one of the Client Applets 130. Due to the highly interactive nature of the system, the user does not have to use all of the pieces of the program. For example, a particular institution may not be concerned with tracking inventory, in which case the institution could simply not use this portion of the system.

In order to access the page 10 shown in FIG. 9, a user logs into the system using an ID and password, in the conventional manner. At login, the Applet Agent 430 establishes a communication with the server 800. Once a connection is established, the client processor requires a port in order to connect with the server. The Applet Agent 430 establishes a socket connection with the server. The server assigns a specific port number for that particular session. Once the port number is established, no other user can use that port. Because only one connection has the socket, a third party cannot connect to this session, even if the third party manages to obtain the particular applet. As discussed above, this feature enhances security. The system also preferably provides secure ID certificates from an encryption company. The use of a single port and encryption provides both a secure socket and super encryption.

After a connection has been established, the Applet Agent 430 is put on standby while a session is established. Once a session is established, the Applet Agent 430 is notified that it is time to start operating. In the preferred embodiment shown in FIG. 9, the Applet Agent 430 initially spawns the Menu Applet 129. The system can have hundreds of different menus 129, with different menus 129 being opened depending on who the user is. Upon successfully logging in, the user preferably receives a personal welcome in frame 3. If a visitor logs in, the system is preferably configured to allow the visitor only to view visitor-access screens. Upon receiving input from the user via the Menu Applet 129, the Applet Agent spawns the Client Applets 130. Once the system of the invention pulls in a Client Applet 130, the Client Applet 130 is cached or stored on the client's processor 436, in the manner described above. The Applet Agent 430 also stores the information in each applet, creating what can be termed a “smart screen.” The client processor never has to go back to the server, except to access new data, retrieve new Client Applets 130, or store data to the server database 1000. All applets reside only on the client's processor, and only during the session. As mentioned above, the Applet Agent 430, rather than the browser, communicates with the web-server. Only the Applet Agent 430 knows the sequence of the screens, i.e. Client Applets 130, that will be called up. The Applet Agent 430 knows the port, and it communicates with the application server through this port. In this manner, there is only one connection between the client's processor and the application server.

As indicated in FIG. 9, software for generating reports 50 can be incorporated into the system of the invention. A preferred software program for generating reports in the system of the invention is Crystal Reports™, although other off-the-shelf data reporting programs can be used. The reporting program 50 can also operate in the system in the form of a Client Applet 130. The reporting function allows users to extract data from the application server database 1000 and present the data in useable formats.

Once logged in, the user can review existing data or enter requested information. In order to illustrate the functionality of the system, an example of data entry for a membership function will be discussed, with reference to FIG. 10. FIGS. 10A-F show preferred embodiments of graphical user interfaces of web pages 10 in an administrative system using the inter-applet communication system of the invention. FIGS. 10A-F also demonstrate sequential use of selected Client Applets in a logical unit of work. The Client Applets 130 shown in FIGS. 10A-F are displayed in frame 3 of the webpage 10 shown in FIG. 9.

FIG. 10A is the first Client Applet 130 in the logical unit of work for the membership function. The Client Applet 130 includes a template for displaying data consisting of personal information for a member of the institution. The template includes fields for data such as title, first name, last name, occupation, birth date, and the like. In a full access mode, a user can modify the data in the template of the Client Applet 130 simply by inputting replacement data. Depending on the needs of the institution, some members may be provided with read only access, so that these members cannot modify the data in the Client Applets 130. As shown in FIG. 10A, the Client Applet is provided with GUI buttons for navigating among Client Applets, such as First 12, Previous 14, Next 16 and Last 18. If the user selected the Next 16 function, the Client Applet 130 would instruct the Applet Agent to retrieve data for the next member, e.g. for Mike Doe. The Applet Agent 430 would record the personal information data for John Doe in the Applet Agent's data cache 436, retrieve the personal information data for Mike Doe from the application server database 1000, and display the personal information for Mike Doe in the first Client Applet 130. A query button 20 is also provided so that a user can search for data for a particular individual, e.g. by inputting the individual's first and last names (e.g. “Mike Doe”). A “Continue” button 208 is also provided. As discussed above, when a user selects Continue 10, the Applet Agent 430 extinguishes the existing Client Applet 130, records that Client Applet's data in the Applet Agent's 430 data cache 436, and retrieves the next Client Applet 130 and its associated data from the server 800. If the user selected Continue 208 before filling in a required data field, such as “Last Name,” the Client Applet 130 would display a message instructing the user to enter data into the required field. In the embodiment shown in FIG. 10A, the error prompt is displayed in message field 32. Once all required data is entered and the user clicks Continue 208, the Applet Agent proceeds to open the next Client Applet 130 in the sequence.

FIG. 10B is the second Client Applet 130 in the “Membership” logical unit of work. The second Client Applet 130 is similar to the first client applet 130, except that it includes a template for displaying and entering data related to the member's address. When the user is ready to view the next set of membership information for John Doe, the user clicks Continue 208, at which point the Applet Agent 430 extinguishes the existing Client Applet 130, records that Client Applet's data in the Applet Agent's 430 data cache 436, and retrieves the next Client Applet 130 and its associated data from the server 800. Additionally, the second Client Applet 130 is provided with an activated Back button 30. If the user selected Back 30, the Applet Agent 430 retrieves the first Client Applet 130 and its current data (i.e. the personal information for John Doe) from its data cache 436, and displays the first Client Applet 130 and its current data in frame 3 of the page 10. By clicking Back 30 and Continue 208, the user is able to toggle between screens containing different data for John Doe. Note, however, that during the toggle function, the Applet Agent 430 does not communicate with the server 800; instead, the Applet Agent 430 simply calls up data from its data cache 436.

After the user selects Continue 208 from the Client Applet of FIG. 10B, the Applet Agent 430 calls up and displays the third Client Applet 130 in the sequence, which is shown in FIG. 10C. The frame of FIG. 10C is similar to that of FIGS. 10A and 10B except that it includes a template for displaying and entering data related to contact information for John Doe.

When the user selects Continue 208 from the Client Applet of FIG. 10C, the Applet Agent 430 calls up and displays the fourth Client Applet 130 in the sequence, which is shown in FIG. 10D. The frame of FIG. 10D is again similar to that of FIGS. 10A, 10B, and 10C except that it includes a template for displaying and entering data related to contact information for John Doe. Note, however, that the Client Applet 130 provides a pull down menu 2001 for “Membership Type.” When “Visitor” is selected from the pull down menu 2001, the Continue 208 function is replaced by a “Submit” 360 function. This means that when John Doe is a “Visitor,” the last Client Applet 130 in the membership logical unit of work has been reached. When the user is finished viewing or entering data into the Client Applet of FIG. 10D, the user will select the Submit 360 function, at which point the Applet Agent 430 updates the data cache 436 with the data from the last Client Applet 130 in the logical unit of work (i.e. records the data) and forwards the final data set for the logical unit of work to the server 800 via the application server agent 900. The data set is then stored in the database 1000 for future use.

Turning now to FIG. 10E, if “Full” is selected from the pull down menu 2001, the Submit 360 function is not provided. Instead, a Continue 208 function is provided. This means that if John Doe is a “Full” member, the last Client Applet 130 in the membership logical unit of work has not yet been reached. Note that all other information in the Client Applet 130 is the same as in FIG. 10D, but because John Doe is a full member, the sequence leader 122 informs the Applet Agent that at least one more Client Applet 130 remains to be called up in this particular logical unit of work. Depending on the needs of the administrative system, the Applet Agent might be instructed to call up an entirely new sequence of Client Applets 130 at this point; this is an example of “branching” off of a logical unit of work into a new logical unit of work, rather than following a linear sequence.

When the user selects Continue 208 from the Client Applet of FIG. 10E, the Applet Agent 430 calls up and displays the fifth Client Applet 130 in the sequence, which is shown in FIG. 10F. The frame of FIG. 10F is again similar to that of FIGS. 10A-E, except that it provides a template for entry of additional information for John Doe. Note also that the Continue 208 function is replaced by a “Submit” 360 function. This means that the last Client Applet 130 in the logical unit of work for full members has been reached. When the user is finished viewing or entering data into the Client Applet of FIG. 10F, the user will select the Submit 360 function, at which point the Applet Agent 430 updates the data cache 436 with the data from the last Client Applet 130 in the logical unit of work (i.e. records the data) and forwards the final data set for the logical unit of work to the server 800 via the application server agent 900. The data set is then stored in the database 1000 for future use.

When the user of the client processor closes his or her browser, the Applet Agent 430 is extinguished, and all of its data is stored in the application server database 1000. The Applet Agent 430 does not reappear until the user logs in again.

One advantage of the invention is that individual users of the system, such as schools, stores, and churches, do not have to devote time and resources to maintaining the system. Because the administrative system is Internet based, the service provider maintains the user's databases (including backing up data), provides Internet access, and periodically updates the software. With conventional desk top administrative programs, the software is loaded onto a stand alone PC. With desktop administrative programs, it becomes difficult and expensive for an individual institution to maintain databases, provide fail safe storage of data, and remain current on software updates. These problems are particularly acute for small businesses and non-profit organizations that do not have sufficient capital to hire full-time network and database administrators. By delegating the foregoing responsibilities to an off-site server, a division of labor occurs. The institution is able to concentrate on administration, while the server concentrates on maintaining and displaying the institution's data.

Because the system is Internet based, institutions can link together and access each other's information. For example, all of the schools in a school system or all of the churches in a parish can elect to share each other's membership information. Additionally, the system can preferably be accessed from any computer that has Internet access. Thus, if an administrator is attending a meeting out of town, the administrator can log into the system, access applicable data, and prepare and print out a report. With conventional desk top administrative programs, the software is loaded onto a stand alone PC. Unless the PC is provided with login access via the Internet, an administrator cannot access administrative data from a remote location.

A preferred embodiment of source code for implementing the above described inter-applet communication processes of the invention is attached hereto as Appendix A.

Although the present invention has been described in terms of specific embodiments, it is anticipated that alterations and modifications thereof will no doubt become apparent to those skilled in the art. It is therefore intended that the following claims be interpreted as covering all alterations and modifications that fall within the true spirit and scope of the invention.

[image]

[image]

[image]

[image]

[image]

[image]

[image]

What is claimed is:

1. A method of providing communication between a server processor and a client processor via a net infrastructure such as the Internet that provides total virtual persistence at the client tier, thereby allowing a state to be maintained at a client tier independently of a server and a database tier, whereby application data remains persistent during an entire session even when working with multiple webpages and whereby application data is kept closest to where it is needed, which reduces the load on the server tier and conserves bandwidth, comprising:
providing a client processor having an Applet Agent operating in a browser thereof, said client processor having a data cache,
providing a server processor having a server agent operating therein, said server agent interconnected to a server database, said server database storing a plurality of Client Applets along with data associated with each said Client Applet,
said Applet Agent sending a request to said server agent for retrieval of a selected Client Applet,
said server agent retrieving said selected Client Applet and said selected Client Applet's data from said server database, and said server agent sending said selected Client Applet and said selected Client Applet's data to said Applet Agent,
said Applet Agent sending said selected Client Applet and said selected Client Applet's data to said browser of said client processor, and
said Applet Agent storing said data of said selected Client Applet in said cache of said client processor, whereby said selected Client Applet's data may be retrieved without accessing said server processor or said server database even after said selected Client Applet has been extinguished.

2. The method of claim 1, further comprising said Applet Agent storing said selected Client Applet in said cache of said client processor, whereby said Client Applet may be re-spawned on said client browser without accessing said server processor or said server database even after said selected Client Applet has been extinguished, and whereby said re-spawned Client Applet may be re-populated with said data cached in said client processor without accessing said server processor.

3. The method of claim 2, further comprising extinguishing said selected Client Applet from said browser of said client processor.

4. The method of claim 3, further comprising
said Applet Agent sending a request to said server agent for retrieval of a second selected Client Applet,
said server agent retrieving said second selected Client Applet and said second selected Client Applet's data from said server database, and said server agent sending said second selected Client Applet and said second selected Client Applet's data to said Applet Agent,
said Applet Agent sending said second selected Client Applet and said second selected Client Applet's data to said browser of said client processor, and
said Applet Agent retrieving said data of said selected Client Applet from said cache and populating said second selected Client Applet with at least some of said data of said selected Client Applet.

5. The method of claim 4, further comprising said Applet Agent storing said data of said second selected Client Applet in said cache of said client processor, whereby said second selected Client Applet's data may be retrieved without accessing said server processor or said server database even after said second selected Client Applet has been extinguished.

6. The method of claim 5, further comprising, upon conclusion of a session, said Applet Agent retrieving said cached data for said selected Client Applets from said cache, said Applet Agent sending said cached data to said server agent, and said server agent sending said cached data to said server database for storage.

7. The method of claim 6, wherein said storage of said cached data on said server database occurs upon conclusion of the session.

8. The method of claim 1, further comprising a user inputting new data into said selected Client Applet, and
said Applet Agent storing said input data in said cache, whereby said selected Client Applet's data may be retrieved without accessing said server processor or said server database even after said second selected Client Applet has been extinguished.

9. A method of providing inter-applet communication in a network system having a host server connected to a client processor via a net infrastructure such as the Internet, the server having an application server processor and a database, the database containing a plurality of Client Applets and data associated with said Client Applets, the client processor having a browser and being operated by a user, comprising:
the application server creating a client, creating a session, initializing a server agent, and setting said client,
spawning an Applet Agent on said client processor,
said Applet Agent initiating a client connect with said server agent, said connection consisting of a dynamic, random port that is used only for one session, said connection serving as the exclusive connection between said client processor and said application server during said session,
said Applet Agent communicating with said server agent to retrieve a selected Client Applet and said selected Client Applet's data from the database,
said server agent retrieving said selected Client Applet and said selected Client Applet's data from the database,
said application server agent transmitting said selected Client Applet and said selected Client Applet's data to said Applet Agent,
said Applet Agent transmitting said selected Client Applet and said selected Client Applet's data to said browser of the client processor, and
operating said Client Applet via a JVM of said client browser.

10. The method of claim 9, further comprising:
a user inputting new data into said selected Client Applet, and registering said new data with said Applet Agent.

11. The method of claim 10, wherein said step of registering said new data with said Applet Agent comprises:
said Client Applet instructing said Applet Agent to retrieve said new data from said Client Applet,
said Client Applet instructing said Applet Agent to register said new data, and
said Client Applet instructing said Applet Agent to take a snap shot of said new data.

12. The method of claim 11, further comprising,
when a user is finished with said Client Applet, sending a log off message to said Applet Agent, whereby said Client Applet is extinguished from the client browser.

13. The method of claim 12, further comprising said Applet Agent sending said new data for said extinguished Client Applet to said application server database for storage.

14. The method of claim 13, wherein said step of sending new data for said extinguished Client Applet to said application server database for storage comprises:
said Client Applet sending a submit message to said Applet Agent,
said Applet Agent submitting said Client Applet's data to the application server agent, and
said application server agent sending said Client Applet's data to the database server for storage.

15. The method of claim 14, further comprising, when a user is finished with said Applet Agent, sending a log off message to said application server agent via said Applet Agent, and
said application server agent logging off said Applet Agent.

16. The method of claim 12, further comprising carrying out the foregoing functions for a plurality of Client Applets, the Client Applets sequenced into a logical unit of work.

17. The method of claim 9, wherein one of said Client Applets is a Menu Applet.

18. The method of claim 9, wherein a plurality of said Client Applets are arranged in a logical unit of work, whereby a finite set of said Client Applets can be used to accomplish multiple functions.

19. The method of claim 18, wherein a sequence leader determines which of said Client Applets will be used in a logical unit of work and the order in which said Client Applets will be used in said logical unit of work.

20. The method of claim 12, further comprising retrieving a second Client Applet to replace said logged out Client Applet, said second Client Applet retrieved in accordance with instructions from a sequence leader for a logical unit of work.

21. The method of claim 20, wherein said step of retrieving a second Client Applet comprises:
sending an addApplet message and a getSnapShot message to said Applet Agent,
said Applet Agent retrieving said new Client Applet and its snapshot data from the application server database,
said Applet Agent spawning said new Client Applet on a browser of the client processor, and
said Applet Agent populating said new Client Applet with pertinent data from one or more of said extinguished Client Applets.

22. The method of claim 21, wherein said Applet Agent further populates said new Client Applet with data received from said application server database via said application server agent.

23. The method of claim 20, further comprising:
the user entering new data into said new Client Applet, and registering said new data with said Client Applet.

24. The method of claim 23, wherein said step of registering new data comprises:
said new Client Applet instructing said Applet Agent to retrieve said new data from said Client Applet,
said Client Applet instructing said Applet Agent to register said new data, and
said Client Applet instructing said Applet Agent to take a snap shot of said data.

25. The method of claim 23, further comprising repeating said steps of initializing new Client Applets, inputting data into the Client Applets, and storing the input data to the Applet Agent until all Client Applets in a logical unit of work have been accessed.

26. The method of claim 25, further comprising, at a conclusion of said logical sequence of work, said Applet Agent sending data from said Client Applets to the application server database for storage.

27. The method of claim 26, wherein said step of sending said data to said database comprises:
a user inputting a Submit function at a last Client Applet in said logical unit of work,
upon receiving said input, said last Client Applet in said logical unit of work sending a submit message to said Applet Agent,
upon receiving said submit message, said Applet Agent submitting said data of said Client Applets in said logical unit of work to said application server agent, and
said application server agent sending said data of said Client Applets in said logical unit of work to said application server database for storage.

28. The method of claim 9, wherein one of said Client Applets is a Menu Applet, said Menu Applet configured to allow selection of said Client Applets.

29. A method of providing a secure network connection between a client processor and an application server processor, the client processor communicating with the application server processor via the Internet using inter-applet communication to thereby provide persistence of data at the client tier, comprising:
spawning an Applet Agent on said client processor,
said Applet Agent initiating a client connect with said server agent, said connection consisting of a dynamic, random port that is used only for one session,
using said connection between said Applet Agent and said server agent as the exclusive connection between said client processor and said application server during said session, and
said Applet Agent retrieving a plurality of Client Applets and data for each said Client Applet from a database of said application server processor, said Applet Agent caching said Client Applet data to thereby maintaining persistence of said Client Applet data on said client processor during said session, said Applet Agent populating said Client Applets with Client Applet data from said cache, said Applet Agent modifying said cached Client Applet data during said session based on input from a user, and said Applet Agent sending said Client Applet data to said application server database via said server agent upon conclusion of said session to thereby store said modified Client Applet data for future use.

30. The method of claim 29, further comprising encrypting data exchanged between said client processor and said application server, to thereby further enhance the secure network connection.

31. A method of providing inter-applet communication in a network system having a host server and a client processor, the server having an application server processor and a database, the database containing a plurality of Client Applets and data associated with said Client Applets, the client processor having a browser and being operated by a user, comprising:
opening a browser on the client processor,
logging the client processor onto the host server via a net infrastructure,
sending a login request from the client processor to the server via a doPost command,
the server, upon receiving the login request, executing a clientConnect command,
the application server initiating a login procedure,
the application server executing an authenticate command to the database server,
pulling the user's login criteria from the database server and forwarding the user's login criteria to the application server,
if the login information entered by the user matches the user's login information in the database, the application server creating a client, creating a session, initializing an agent, and setting said client,
spawning an Applet Agent on said client processor,
said Applet Agent initiating a client connect with said server agent, said connection consisting of a dynamic, random port that is used only for one session,
using said connection between said Applet Agent and said server agent as the exclusive connection between said client processor and said application server during said session,
selecting a Client Applet via input from the user on the client processor,
said client processor submitting an addApplet message and a getSnapShot message to said Applet Agent,
said Applet Agent submitting a request for said selected Client Applet and said snapshot data directly to said application server agent,
said application server agent submitting said add applet message to the database server,
retrieving said selected Client Applet and its snapshot data from the database,
transmitting said selected Client Applet and its snapshot data to the application server agent,
said application server agent transmitting said new Client Applet and its snapshot data to said Applet Agent,
said Applet Agent transmitting said selected Client Applet and its snapshot data to said web browser of the client processor, and
operating said Client Applet via a JVM of said client browser.

32. In a web browser for a client processor having a graphical user interface including a display and a selection device, a method of providing and selecting from a menu on the browser display, the method comprising:
displaying an Applet Agent on a web-page on the browser, said Applet Agent interconnected to a server agent of a server processor, said server processor interconnected to a server database, said server database storing a plurality of Client Applets and data for each of said Client Applets, one of said Client Applets being a Menu Applet,
displaying said Menu Applet on said webpage on the browser simultaneously with said Applet Agent, said Menu Applet providing options for selecting among logical units of work, each said logical unit of work consisting of a plurality of said Client Applets,
receiving input on said Menu Applet for selection of a selected logical unit of work,
in response to the input, said Menu Applet sending said selection to said Applet Agent, said Applet Agent sending said selection to said server agent, said server agent retrieving a first Client Applet in said logical unit of work and said first Client Applet's data from said server database, said server agent sending said first Client Applet and said first Client Applet's data to said Applet Agent,
said Applet Agent caching said first Client Applet and said first Client Applet's data, and
said Applet Agent displaying said Client Applet on said web-page on the browser simultaneously with said Applet Agent and said Menu Applet.

33. The method of claim 32, further comprising updating data in said cache based on input from the user, and retrieving and replacing Client Applets until said logical unit of work is completed.
